(19) United States
(12) Patent Application Publication
(10) Pub. No.: US 2004/0068558 A1
(43) Pub. Date: Apr. 8, 2004

(54) Method for providing communication waiting times between at least two data nodes

(76) Inventor: Miguel De Miguel, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/467,655

(22) PCT Filed: Feb. 12, 2002
(86) PCT No.: PCT/FR02/00527

(30) Foreign Application Priority Data
Feb. 12, 2001 (FR) 01/02172

(51) Int. Cl. G06F 15/173

(52) U.S. Cl. 709/223

(57) ABSTRACT

The invention is a method to ensure the latency time of communications between at least two data nodes according to an object-oriented Java-RMI or CORBA protocol. This method is characterized in that it implements in each node an RSVP resource reservation protocol in the middleware layer of Java-RMI or CORBA, intermediate between the operating system and the application layers, integrating the resources reservation processes and services and the communication processes in said middleware layer.

The present invention relates to a method to ensure the latency time of communications between at least two data nodes.

In distributed real-time data processing systems, processing time constraints impose prediction of processing times in order to ensure end-to-end timeliness of trans-node application behaviors. The resource reservation technique offers a response to this requirement, but only in certain cases, as we shall see below.

The Java language has already been used in the real-time systems. However, this language does not enable latency and blocking times to be easily limited, notable during processes such as “garbage collection” or in scheduling algorithms and synchronization process protocols. Java working groups (“Java Consortium”, “Real-Time for Java Experts Group”) have proposed to extend Java's specifications and APIs (application programming interfaces). These extensions enable implementation of Java programs with prediction capacities, providing possibilities of reservation of computing time and of other resources, such as garbage collection time. However, these extensions do not take account of the principles of distributed programming inherent in Java and they do not resolve the current problem of absence of prediction functions in Java's distributed programming capabilities, such as RMI (Remote Method Invocation), EJB (Enterprise JavaBeans) and JNDI (Java Naming and Directory Interface). To limit the impact of these problems, D. Jensen's group has established the “JSR-000050 The Distributed Real-Time Specification for Java” specification (“JSR” meaning Java Specification Request). This group and the SUN company have drawn up a new JSR in order to develop the concepts relating to this specification. The main goal of this Java request is to extend the specifications of Real-Time Java and Java itself in order to enable the prediction of Java program processing times in a node-to-node communication.

Moreover, the known CORBA (Common Object Request Broker Architecture) system is an open distributed object computing infrastructure providing a middleware (MW) framework between the operating system and the application layers. Java-RMI (Remote Method Invocation) and CORBA programs include a MW layer enabling users to invoke operations performed by distributed objects. In March 1999 the well-known working group OMG (“Object Management Group”) published an OMG standard for real-time CORBA applications. In August 2000, this group published the “Dynamic Scheduling Real-Time CORBA” specifications that extend the CORBA real-time standard mentioned previously by adding support for dynamic scheduling algorithms. The aim of these specifications is to extend the CORBA standard in order to facilitate end-to-end predictability in distributed systems and to provide support for resource management in the CORBA environment. The ability to predict end-to-end timeliness of task execution is possible only if we respect the priorities of the processes between the client and the server, in order to resolve resource contention problems, and if we limit priority inversions of resource usage, and if we limit the latency time of operation invocations. Yet it is clearly stated in this publication that the authors propose no solution enabling latency to be limited in relation to the operating system, to specific applications and above all to the communication means.

The article by Chao-Ju Hou, Ching Chih Han and Yao-Min Chen “Communication middleware and software for QoS control in distributed real-time environments”, published in Computer Software and Applications Conference, 1997. COMPSAC '97. PROCEEDINGS, The Twenty First Annual International Washington, D.C., USA 13-15 Aug. 1997, Los Alamitos, Calif., USA, IEEE COMPUT. SOC., US. dated 13 Aug. 1997, pages 558-564, describes a communication process making use of the RSVP protocol (“Resource ReServation Protocol”). But this document offers no solution to the problems raised by the use of this protocol. Moreover, although this document mentions the middleware, it does not associate it either with CORBA or JAVA-RMI.

The object of the present invention is a method enabling prediction of program processing times, in particular real-time Java programs on client-server platforms, running on several nodes and using the RMI method in the middleware layer.

More generally, the object of the invention is a method that ensures the latency time of communications between at least two data nodes by means of resource reservation in the communication understructure in a MW layer.

According to the invention, the method for ensuring the communication latency time between at least two data nodes, employing an object-oriented Java-RMI or CORBA protocol, is characterized in that it implements in each node an RSVP resource reservation protocol in the middleware layer of Java-RMI or CORBA, intermediate between the operating system and the application layers, integrating the resources reservation processes and services and the communication processes in said middleware layer.

According to a characteristic of the invention, the interface between the middleware layer and the application is extended to give it access to the reservation services according to the RSVP protocol.

According to another characteristic of the invention, the reservation is associated with various software items involved in the communication according to the remote references approach. The operations associated with the remote references include operations to determine the bandwidth to use, the maximum data packet size and the maximum size of the necessary buffers. The RSVP protocol handles the reservation of resources on the path between two remote Java-RMI or CORBA objects. Each remote reference specifies the time distribution of its invocations, and a specific reservation is made for each remote reference.

Therefore, the method according to the invention implements a resource reservation protocol in the MW layer by integrating the resource reservation processes and services and the communication processes in the MW layer. This integration ensures compatibility between the protocols handling the communication in the MW layer and the resource reservation protocols.

By extending the interface between the MW layer and the application to give it access to the reservation services it is possible to specify the time requirements when a remote communication is established and to be sure of a predetermined response time.

Other characteristics and advantages of the invention will become evident on reading the detailed description below of a potential embodiment, which is non-limitative and taken only as an example, with reference to the attached drawings of which:

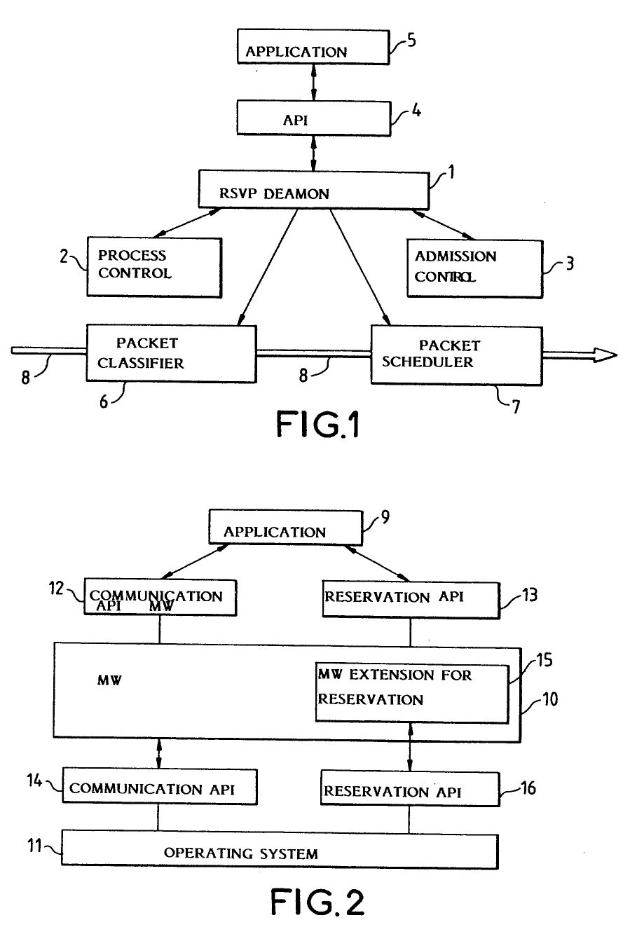

FIG. 1 is a diagram of a known resource reservation protocol;

FIG. 2 is a simplified diagram of the essential elements involved in the implementation of the method according to the invention.

The present invention is described below with reference to data interchange between two or more nodes (microcomputers for example) connected via a network such as the Internet and using a protocol such as Java-RMI. However it is of course not limited to this application nor to this protocol, since it is applicable to other applications requiring packet-mode transmission of data between at least two points (or nodes), using a Java-RMI or CORBA protocol. These protocols are described for example in the specifications of the Sun Microsystems company (Java Remote Method Invocation Specification for JDK 1.2) and in the OMG working group document entitled “Real-Time CORBA 1.0 Spec, OMG Document number ptc/00-09-02”, respectively.

FIG. 1 illustrates the principle of implementation of a known resource reservation protocol via an API. This protocol is mainly implemented in a node by a background routine 1 (commonly called a “daemon”). The protocol here is of RSVP type (“Resource ReServation Protocol”), which is well known (see, for example, the article by Zhang, S. Berson, S. Herzog and S. Jamin entitled “Resource reSerVation Protocol (RSVP)—Version 1 Function Specification”, Internet RFC 2205, 1997). The daemon 1 is linked bidirectionally with a process control program 2 and an admission control program 3, and with a reservation interface 4 (RAPI), as described for example in the document by R. Braden and D. Hoffman entitled “RAPI—An RSVP Application Programming Interface”, Internet Draft of August 1998 operating with a “Windows QoS Socket Library” described in the document of Y. Bernet, J. Stewart, R. Yavatkar, D. Andersen, C. Tai, B. Quinn and K. Lee entitled “Winsock Generic QoS Mapping (Draft)”, of the Microsoft company. This interface 4 is itself linked bidirectionally with an application 5. The routine 1 controls a packet classifier 6 and packet transmission scheduler 7. The classifier 6 receives a data stream 8 that it transforms into packets, and the scheduler 7 sends these packets taking account of the capacities of the network they must transit. Most of the functions of the API 4 require a session descriptor as an input parameter. A session is set up in the sending node, and the receiving node identifies the “socket” addresses of the session packets (IP addresses and port number of the receiver). The interface 4 must be used jointly with a “socket” API interface. The “socket” file descriptors, which provide the “socket” functions (“bound”, “accept”, “connect”), are used to the create reservation sessions of the interface 4.

The daemon 1 communicates with the routines of the routers along the session path, and all these routines together handle the reservation of the resources indicated by the sender and the receiver. The reservation objects enable the data-rate of the token buckets to be specified, in addition to their depth, maximum data-rate and maximum size. In the reservation process, the characterization of the data flow describes the required quality of service (QoS). The “guaranteed QoS” parameter ensures that the data packets will arrive at their destination within the allotted guaranteed time and will not be rejected in the event of queue overflow. This parameter characterizes the maximum bandwidth for an end-to-end transmission over the data path. The receiver's application provides a filtering specification indicating to the intermediate reservation service routers which senders must be included in the reservation process. In this manner the receiver's applications can attach the corresponding QoS only to data coming from the sender's applications.

The node diagram (sender or receiver) in FIG. 2 shows the main logical components involved in a resource reservation process according to the invention. The layers of this node are the application layer 9, the MW layer 10 and the operating system 11. The application 9 communicates with layer 10 via a communication API 12 and sends its reservation requests via a reservation API 13.

The middleware layer 10 communicates with the communication protocol routine 14 of the operating system 11. At the same time an RSVP resource reservation routine 15 of the layer 10 communicates with a reservation protocol routine 16 of the operating system 11. In this structure, the operating system reservation routine 16 does not need to be adapted to each new application, so it can be a standard routine. Only the routine 15 is specific of the MW layer 10, but since it is in this layer it can be adapted to each application (the middleware is much easier to modify than the operating system). In the embodiment described here layer 10 is a Java-RMI layer, but it could be of CORBA type.

The aim of the invention is to implement distributed Java software (or similar) applying remote invocation processes and responses within deadlines that can be predicted. The reservation protocols provide a support that enables the transit time during communications to be limited. These protocols have two types different of sessions: invocation sessions associated with the remote invocation and response sessions associated with the replies to remote invocations.

Different solutions can be used to attach the reservation to different software components. According to a preferred feature of the invention, this is done using the remote references approach. In this case, each remote reference specifies the time distribution of its invocations, and a specific reservation is made for each remote reference. According to the invention, the remote Java references identify the sender of the reservation which originated the invocation session, and the server does the same for the response sessions. The remote reference is associated with two reservation sessions. Two different remote references belonging to the same object or virtual machine can reference the same server and can be associated with remote reservations.

Other possible reservation association solutions include the “client object” approach according to which the client specifies the time distribution of its remote invocations for each server. According to the invention, the client object is then associated with the sender of the invocation sessions and with the receiver of the response sessions. On the client side, two reservation sessions are associated with each server used. This solution reserves resources for each communication between a client and a server.

In the case of use of Java language, a Java virtual machine approach could also be implemented according to the invention. In this system the virtual machine specifies the time distribution of the its remote invocations for each server. According to the invention, the client virtual machine is associated with the sender of the invocation sessions and with the receiver of the response sessions. Two reservation sessions are associated with the virtual machine for each remote server. This solution enables resources to be reserved for each communication between a client machine and a server.

As explained above, the preferred embodiment of the invention is the “remote references” approach because it enables different threads (tasks) to establish, and therefore to encapsulate their own reservation, which avoids the competition problems that can arise with other solutions. As a matter of fact, with the second and third approaches described above, a second task can modify the reservation of a first task, which will change the response time. In these two solutions, threads must approve their reservation times. According to the first approach, the reference can be a local variable of the task and the reservation is fixed within the task.

In the first approach, the server and the references negotiate the reservation from a Java-Reservation set that is an extension of the Java-RMI API. These extensions enable identification of the methods that will be invoked by the reference to the server, and the time distribution of the invocations. Another type of reservation is the simple reservation according to which the references establish the bandwidth of the invocation and response sessions. The second approach is interesting when the size of all the invocations and replies cannot be evaluated statistically.

The RMI invocation method can be implemented using the JDK (Java Development Kit) tool, in its version 1.2 for example. However, this implementation poses several problems that the invention resolves as described below, in the case of the remote references approach.

When two tasks use the same remote reference at the same time, they use two different connections and therefore two different “sockets”. This can also occur when two RMI-type callbacks are used and the client calls back the server before the first callback is finished. In this case the RMI procedure uses two “sockets” to communicate the same reference with the same server. This method presents incompatibilities with the session reservation approach by API interfaces, and with the three approaches described earlier (association of the reservation with different software items). As a matter of fact, the RSVP protocol is “session-oriented” whereas the JDK 1.2 implementation is “connection-oriented”. The JDK 1.2 uses an unlimited number of “sockets” for each reference, whereas the reservations are associated with RSVP sessions that require only one “socket”.

To resolve this problem, the invention proposes the following solution, which is valid when using Java-RMI, with the JDK 1.2 tool. The reservation sessions associated with the communications between remote references and server necessitate only one “socket” for all the invocations. The JDK 1.2 tool uses (or reuses) one connection for the invocation, and one “socket” is associated with each connection. JDK 1.2 does not provide for use of the same connection in parallel for two invocations, since this would cause competition situations during the call marshalling sequences and the creation of remote calls. The connection-oriented approach enables the replies to be associated with the invocations (the values returned are sent using the same connection as for the invocation), which could result in another competition situation if we do not respect the present solution. The JRMP protocol provides multiplexing possibilities (see the article by Sun Microsystems: “Java Remote Method Invocation Specification” published in October 1998). The aim is to provide a model in which two terminal points can each open multiple full-duplex connections with the other point in an environment in which only one of the terminal points is able to open such a bidirectional connection by using other possibilities. In the present case, we exploit the multiplexing abilities of the RMI invocation to re-use the same “socket” for all the methods of invoking the same reference, and the reservation session is generated with this “socket”. The JDK 1.2 tool recognizes the arrival of multiplexed packets in the transport task (“TCPTransport”) and produces a multiplexed TCP channel to route these packets. However, this tool does not enable configuration of the client multiplexing and the implementation on the receiver side implies unlimited blocking times: the implementation makes use of “wait” instructions and includes new tasks that do not limit the blocking times. The server classes of the JDK tool must then be adapted, as on the client side.

Another problem linked to JDK 1.2 is the following: the “socket” address is encapsulated in the JDK sub-system. However this information is necessary to create reservation sessions. If we create a new layer (reservation layer), the references and transport layers must include new functions. The invention proposes to modify the implementation of JDK 1.2 such that the “socket” is associated with the remote reference by using the extensions that were used to construct the reservation sessions.

These problems and their solutions are described in the article by Miguel A. de Miguel published in Proceedings of ISORC 2001 (May 2001) and entitled “Solutions to make Java RMI Time Predictable”.

1. Method to secure the latency time of communications between at least two data nodes and employing an object-oriented Java-RMI or CORBA protocol, characterized in that it implements in each node an RSVP resource reservation protocol in the middleware layer (10) of Java-RMI or CORBA, intermediate between the operating system (11) and the application layers (9), integrating the resources reservation processes and services (15) and the communication processes in said middleware layer.

2. Method according to claim 1, characterized in that extensions of the interface between said middleware layer and the application are made to give it access to the reservation services according to the RSVP protocol.

3. Method according to one of claims 1 or 2, characterized in that the reservation is associated with the various software items involved in the communication according to the remote references approach.

4. Method according to the claim 3, characterized in that the operations associated with the remote references include operations to determine the bandwidth to use, the maximum data packet size and the maximum size of the necessary buffers.

5. Method according to claim 3 or 4, characterized in that the RSVP protocol ensures resources reservation on the path between two remote Java-RMI or CORBA objects.

6. Method according to one of claims 3 to 5, characterized in that each remote reference specifies the time distribution of its invocations, and that a specific reservation is made for each remote reference.

7. Method according to claim 6, characterized in that the remote references identify the sender of the reservation which originated the invocation session, and that the server does the same for the response sessions.

8. Method according to claim 7, characterized in that the remote reference is associated with two reservation sessions and that two different remote references belonging to the same object or virtual machine reference the same server and are associated with remote reservations.
